(19) United States
(12) Patent Application Publication
(10) Pub. No.: US 2007/0182898 A1
(43) Pub. Date: Aug. 9, 2007

(54) Retardation plate with protective film, method of manufacturing thereof, pressure-sensitive adhesive type retardation plate with protective film, and pressure-sensivie adhesive type optical material with protective film

(75) Inventors: Takashi Yamaoka, Osaka (JP); Masao Higami, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/659,960

(22) PCT Filed: Aug. 4, 2005
(86) PCT No.: PCT/JP05/14330

§ 371 Date: Feb. 12, 2007

(30) Foreign Application Priority Data
Aug. 19, 2004 (JP) 2004-239727

(51) Int. Cl. G02F 1/1335

(52) U.S. Cl. 349/117

(57) ABSTRACT

A retardation plate with protective films of the present invention comprises a retardation plate; and at least two protective films that each comprise a base film and a pressure-sensitive adhesive layer formed on one side of the base film and are sequentially laminated on the retardation plate, wherein the first protective film laminated on the retardation plate differs in adhesive strength to adherend from the protective film or films other than the first protective film, and the first protective film has the lowest adhesive strength. The retardation plate with protective films can suppress curling and has good workability and good peelability even when using a thin retardation plate.

### TECHNICAL FIELD

The present invention relates to a retardation plate with protective films and a method of manufacturing thereof. The retardation plate may be used for a variety of image displays such as liquid crystal displays, organic electroluminescent displays and plasma display panels. In a manufacturing process, the retardation plate with protective films can form a retardation plate-laminated product or a retardation plate-laminated product without impairing workability or appearance.

The present invention also relates to a pressure-sensitive adhesive type retardation plate with protective films including the retardation plate with protective films and a pressure-sensitive adhesive layer formed thereon. The pressure-sensitive adhesive type retardation plate with protective films may be used to form a pressure-sensitive adhesive type optical material with protective films having a laminated optical material including an optical film such as a polarizing plate for use in a variety of image displays, glass, a plastic film, or the like.

### BACKGROUND ART

Retardation plates are used for liquid crystal displays and other various types of displays. Stretched films produced by uniaxially or biaxially stretching polymer films such as films of polycarbonate, cyclic polyolefin, polyester, cellulose, polyimide, or any modification thereof are known to be used as retardation films. Oriented liquid crystal films are also known which are produced by forming a coating of a liquid crystal material such as a liquid crystal monomer or polymer on an alignment substrate, orienting the liquid crystal material and then fixing the liquid crystal material by curing or the like. A laminate of these films is also used as a retardation plate. The thickness of retardation plates is conventionally 60 μm or more but decreases with each passing year. In recent years, the thickness of retardation plates has reached about 1 to 60 μm.

A retardation plate is generally cut into desired shapes, and the resulting retardation plates (in the form of a sheet) are laminated with each other or each laminated with any other optical material and implemented in a variety of image displays. In order to prevent rupture and the like, a protective film is generally attached to a retardation plate. As the thickness of retardation plates is reduced, however, a cut sheet (a retardation plate) can be significantly curled due to a slight difference in tension when a protective film is laminated on the retardation plate, so that there may be a problem in which the lamination with other optical materials becomes difficult. Another problem also occurs in which when the cut sheet is handled, local stress is applied due to folding or the like so that the retardation plate can undergo a local change in retardation or can be frequently ruptured or broken.

A pressure-sensitive adhesive film including a pressure-sensitive adhesive layer and a base film of a polyolefin resin such as polyethylene, polypropylene, or a polyethylene-polypropylene blend is used as a protective film for retardation plates (see Patent Document: Japanese Patent Application Laid-Open (JP-A) No. 2002-363510). However, as the thickness of retardation plates is reduced, curling becomes significant, so that folding can easily occur, or the plates can easily suffer flaws, even when such a protective film is used. Therefore, the protection performance of the protective film has become insufficient. Against these problems, there is a method of using a thicker base film for the protective film. In this method, however, the capability of laminating with a thin retardation plate can be generally reduced so that the protective film can separate or peel off. In order to overcome this problem, the adhesive strength of the protective film may be increased. However, such an increased adhesive strength prevents the protective film from having the required peelability.

Besides the polyolefin resin, high-protection-performance polyester resins such as polyethylene terephthalate are used as a material for the base film of the protective film. However, there is a significant difference in elastic modulus between the polyethylene terephthalate film and the thin retardation plate, and therefore the problem of curling tendency cannot be overcome. In general, the adhesive strength between the protective film and the thin retardation plate is often so high that it can be difficult to separate the protective film. In order to overcome this problem, protective films with low adhesive strength may be used. In such a case, however, separation or peeling can occur due to the lamination performance with the thin retardation plate.

### DISCLOSURE OF THE INVENTION

### Problems to be Solved by the Invention

It is an object of the present invention to provide a retardation plate with protective films that can suppress curling and has good workability and good peelability even when using a thin retardation plate and to provide a method of manufacturing thereof.

It is another object of the present invention to provide a pressure-sensitive adhesive type retardation plate with protective films obtained from the retardation plate with protective films and to provide a pressure-sensitive adhesive type optical material with protective films.

### MEANS FOR SOLVING THE PROBLEMS

As a result of active investigations for solving the problems, the inventors have found that the objects can be achieved with the protective film for a retardation plate and other techniques described below and have completed the present invention.

The present invention related to a retardation plate with protective films, comprising:

a retardation plate; and

at least two protective films that each comprise a base film and a pressure-sensitive adhesive layer formed on one side of the base film and are sequentially laminated on the retardation plate, wherein

the first protective film laminated on the retardation plate differs in adhesive strength to adherend from the protective film or films other than the first protective film, and

the first protective film has the lowest adhesive strength.

In the retardation plate with protective films of the present invention, pluralities of protective films are laminated on a retardation plate. Even when a thin retardation plate is used, therefore, the total of the protective films can ensure a thickness that can suppress curling. Since a plurality of protective films can be sequentially laminated on the retardation plate, high lamination performance can be achieved. Since the first protective film whose adhesive strength is the lowest among the protective films is attached to the retardation plate, separation or peeling can be suppressed between the laminated protective films.

In the retardation plate with protective films of the present invention, the retardation plate is protected by the plurality of the protective films, so that it can be prevented from suffering defects such as local destruction when handled for working and can be worked into a product form while the workability is kept high. The occurrence of curling can also be reduced in the cut pieces of the retardation plate.

In the retardation plate with protective films of the present invention, the first protective film directly attached to the retardation plate has the lowest adhesive strength, and thus all the layered protective films can be separated at once from the retardation plate, and the peelability is good.

In the retardation plate with protective films, the difference between the adhesive strengths of the first protective film laminated on the retardation plate and a second protective film adjacent to the first protective film is preferably 0.05 N/50 mm or more.

In order to ensure the good peelability of the protective films, it is necessary to prevent peeling at the interface between the protective films. In view of such peelability, the adhesive strength at the interface between the protective films is preferably at least 0.05 N/50 mm higher than that at the interface between the retardation plate and the first protective film. The adhesive strength difference is more preferably 0.07 N/50 mm or more, still more preferably 0.09 N/50 mm or more. In view of the lamination performance of a second protective film, the adhesive strength difference is preferably 2 N/50 mm or less, more preferably 1.5 N/50 mm or less.

When three or more protective films are laminated, the adhesive strength of the third or higher protective film is also preferably at least 0.05 N/50 mm higher than that at the interface between the retardation plate and the first protective film. When three or more protective films are laminated, the adhesive strengths of the second and higher protective films is preferably controlled to be at substantially the same level, or the difference between the adhesive strengths is preferably controlled to be within ±0.5N/50 mm, in order to prevent peeling at the interface between the protective films.

In the retardation plate with protective films, the first protective film laminated on the retardation plate preferably has an adhesive strength of 0.01 N/50 mm to 0.3 N/50 mm.

The adhesive strength of the protective film attached to the retardation plate is preferably in the above range, in view of the peelability and the protection performance of the protective film. The adhesive strength of the first protective film attached to the retardation plate is more preferably from 0.02 to 0.2 N/50 mm. If the adhesive strength is higher than 0.3 N/50 mm, the problem of retardation plate deformation or the like may easily occur, or the working speed may be low, when the first protective film is separated from the retardation plate. If the adhesive strength is lower than 0.01 N/50 mm, the problem of easy separation from the retardation plate or the like may occur in every process.

In three retardation plate with protective films, the base film of the first protective film laminated on the retardation plate is preferably a polyolefin-type film, and the base film of the other protective film is preferably a polyester-type film.

Polyolefin films have a lower elastic modulus than polyester films. Thus, the first protective film having a polyolefin-type film as the base film can be well attached to the retardation plate. If a second protective film having, as the base film, a polyester-type film with a relatively high elastic modulus is attached to the first film, the curl generated with the first protective sheet having the polyolefin-type film can be reduced. If the protective sheets are laminated on the retardation plate in this order, the handleability should be good when cut pieces of the retardation plate in the form of a sheet are laminated with any other optical material, and the occurrence of defects such as destruction can also be suppressed.

In the retardation plate with protective films, the retardation plate having a thickness of 1 μm to 60 μm can be preferably used.

The retardation plate for use in the retardation plate with protective films of the present invention may have any thickness, which may be out of the above range. In particular, the present invention is preferably applied to retardation plates using materials which would otherwise easily suffer a change in retardation, folding, cracking, or rupture by handling.

The present invention is also related to a method of manufacturing the above retardation plate with protective films, comprising:

providing at least two protective films that each comprise a base film and a pressure-sensitive adhesive layer formed on one side of the base film and differ from one another in adhesive strength to adherend;

laminating, on the retardation plate, a first one of the protective films that has the lowest adhesive strength; and

then laminating the other protective film or films sequentially.

The present invention is also related to a pressure-sensitive adhesive type retardation plate with protective films, comprising the above retardation plate with protective films and a pressure-sensitive adhesive layer formed on a side of the retardation plate where no protective film is laminated.

The present invention is further related to a pressure-sensitive adhesive type optical material with protective films, comprising the above pressure-sensitive adhesive type retardation plate with protective films and another optical material laminated on the retardation plate through the pressure-sensitive adhesive layer.

A pressure-sensitive adhesive layer may be formed on the retardation plate with protective films of the present invention to form a pressure-sensitive adhesive type retardation plate with protective films. The pressure-sensitive adhesive type retardation plate with protective films can be laminated on other optical materials with good handleability and without causing defects such as destruction. The layered protective films can also be easily separated so that product forms of retardation plate-type optical materials can be produced in good yield.

### BRIEF DESCRIPTION OF DRAWINGS

FIG. 1 is a cross-sectional view showing an example of the retardation plate with protective films of the present invention;

FIG. 2 is a cross-sectional view showing an example of the pressure-sensitive adhesive type retardation plate with protective films of the present invention; and

FIG. 3 is a cross-sectional view showing an example of the pressure-sensitive adhesive type optical material with protective films of the present invention.

### DESCRIPTION OF THE REFERENCE NUMERALS

In the drawings, reference numeral 11 represents a first protective film, 12 a second protective film, 2 a retardation plate, 3 a pressure-sensitive adhesive layer, 4 a separator, and 5 an optical material.

### BEST MODE FOR CARRYING OUT THE INVENTION

The retardation plate with protective films, pressure-sensitive adhesive type retardation plate with protective films and pressure-sensitive adhesive type optical material with protective films of the present invention are described below with reference to the drawings.

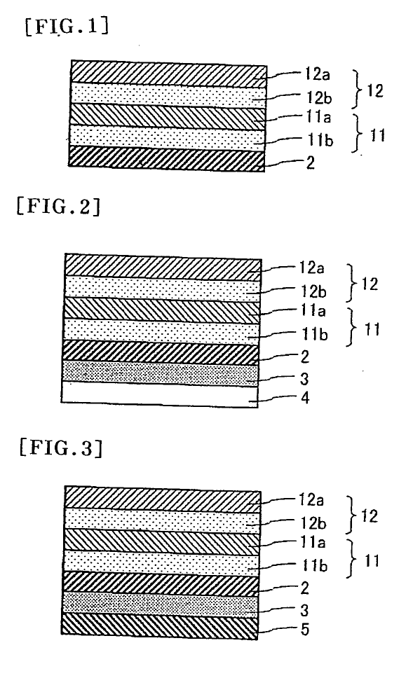

FIG. 1 is a cross-sectional view showing a retardation plate with protective films that includes a retardation plate 2 and first and second protective films 11 and 12 attached on one side of the retardation plate 2 in this order. The first protective film 11 includes a base film 11a and a pressure-sensitive adhesive layer 11b provided on one side of the base film 11a. The second protective film 12 includes a base film 12a and a pressure-sensitive adhesive layer 12b provided on one side of the base film 12a. While FIG. 1 shows a case where two protective films are laminated, any number of protective films may be laminated as long as the number is two or more. Since an increase in the number of the laminated protective films leads to an increase in cost, however, the number of the laminated protective films is preferably two or three or so.

Among the protective films to be laminated, a protective film having the lowest adhesive strength is used as the first protective film 11 laminated on the retardation plate 2. In FIG. 1, the first protective film 11 used has a lower adhesive strength than the second protective film 12 used. Even in cases where three or more protective films are laminated, a protective film having the lowest adhesive strength is used as the first protective film 11.

FIG. 2 is a cross-sectional view showing a pressure-sensitive adhesive type retardation plate with protective films that includes the retardation plate with protective films of FIG. 1 and a pressure-sensitive adhesive layer 3 provided on the retardation plate 2 side where neither the first protective film 11 nor the second protective film 12 is attached. As shown in FIG. 2, a separator 4 may also be provided on the pressure-sensitive adhesive layer 3.

FIG. 3 is a cross-sectional view showing an optical material with protective films that includes the pressure-sensitive adhesive type retardation plate with protective films of FIG. 2 and another optical material 5 laminated through the pressure-sensitive adhesive layer 3 on the pressure-sensitive adhesive type retardation plate with protective films of FIG. 2. The optical material 5 may use a laminate of optical materials.

The retardation plate may be a birefringent film that is formed by uniaxially or biaxially stretching polymer materials. These polymer materials make oriented materials (stretched film) using a stretching process and the like. As polymer materials, for example, polyvinyl alcohols, polyvinyl butyrals, polymethyl vinyl ethers, poly hydroxyethyl acrylates, hydroxyethyl celluloses, hydroxypropyl celluloses, methyl celluloses, polycarbonates, polyarylates, polysulfones, polyethylene terephthalates, polyethylene naphthalates, polyethersulfones, polyphenylene sulfides, polyphenylene oxides, polyaryl sulfones, polyvinyl alcohols, polyamides, polyimides, polyolefins, such as cyclic polyolefin, polyvinyl chlorides, cellulose-type polymer, or bipolymers, terpolymers, graft copolymers, blended materials of the above-mentioned polymers may be mentioned.

The retardation plate may be an oriented liquid crystal film that is produced by forming a coating of a liquid crystal material such as a liquid crystal monomer or a liquid crystal polymer, orienting the liquid crystal material and then fixing the liquid crystal material by curing or the like. As liquid crystal polymers, for example, various kinds of polymers of principal chain type and side chain type in which conjugated linear atomic groups (mesogens) demonstrating liquid crystalline orientation are introduced into a principal chain and a side chain may be mentioned. As examples of principal chain type liquid crystal polymers, polymers having a structure where mesogen groups are combined by spacer parts demonstrating flexibility, for example, polyester based liquid crystal polymers of nematic orientation property, discotic polymers, cholesteric polymers, etc. may be mentioned. As examples of side chain type liquid crystal polymers, polymers having polysiloxanes, polyacrylates, polymethacrylates, or polymalonates as a principal chain structure, and polymers having mesogen parts comprising para-substituted ring compound units providing nematic orientation property as side chains via spacer parts comprising conjugated atomic groups may be mentioned. These liquid crystal polymers, for example, is obtained by spreading a solution of a liquid crystal polymer on an orientation treated surface where rubbing treatment was performed to a surface of thin films, such as polyimide and polyvinyl alcohol, formed on a glass plate and or where silicon oxide was deposited by an oblique evaporation method, and then by heat-treating. It may also be a product that is prepared by spreading, on an alignment surface, a liquid crystal monomer capable of forming the liquid crystal polymer, heat-treating the monomer to orient it and then curing the monomer with ultraviolet light or the like.

A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The protective film has the pressure-sensitive adhesive layer on one side of the base film. The base film and the pressure-sensitive adhesive layer may be any of those generally used for protective films, and the first protective film, the second protective film and so on are selected such that they satisfy the above conditions, before use.

As the base film used for protective films, isotropic or nearly-isotropic film materials are generally selected in terms of properties for see-through test or management of optical films. Examples of such film materials include transparent polymers such as polyester-type resin such as polyethylene terephthalate films, cellulose-type resin, acetate resins, polyethersulfone-type resin, polycarbonate-type resin, polyamide-type resin, polyimide-type resin, polyolefin-type resin, and acryl-type resin. The base film may have two or more layers.

For the purpose of preventing degradation or the like, the base film may contain an antioxidant, an ultraviolet absorbing agent or a light stabilizer such as a hindered amine light stabilizer. The base film may also contain any appropriate additives such as a filler, such as calcium oxide, magnesium oxide, silica, zinc oxide, and titanium oxide, a pigment, an agent for preventing the formation of an eye discharge-like residue, a lubricant, and an anti-blocking agent, or a crosslinking and the like.

Examples of the pressure-sensitive adhesive that forms the pressure-sensitive adhesive layer of the protective film include acry-type pressure-sensitive adhesives, ethylene-vinyl acetate copolymers, natural rubber-type pressure-sensitive adhesives, and synthetic rubber-type pressure-sensitive adhesives such as polyisobutylenes, butyl rubbers, styrene-butylene-styrene (SBS) copolymers, and styrene-isoprene-styrene block copolymers. Any of these materials may be used in the form of a blend.

If necessary, a pressure-sensitive adhesive composition may be used which is prepared by mixing the pressure-sensitive adhesive with a tackifier resin or a softener, such as rosin resin, terpene resin, aromatic petroleum resin, polybutene, polyisobutene, coumarone-indene resin, phenolic resin, and xylene resin, for the purpose of controlling the above properties, the adhesive strength, or the like. The pressure-sensitive adhesive may also contain filler, an age resistor, a crosslinking agent, a pigment, or the like. The pressure-sensitive adhesive layer may also be formed as a laminate of layers different in composition, type or the like on the protective base material.

For example, the method for manufacture of the protective film may use a multilayer co-extrusion method that includes co-extruding the base film material and the pressure-sensitive adhesive by an inflation or T-die process or may use a method that includes extruding the base film and the pressure-sensitive adhesive separately and then laminating them. Alternatively, the protective film may be prepared by forming the pressure-sensitive adhesive layer on the base film by other appropriate methods. Examples of such methods include: a method that includes dissolving or dispersing a base polymer and any other component in one or a mixture of appropriate solvents such as toluene and ethyl acetate to form an about 10 to 40% by weight pressure-sensitive adhesive liquid and then directly applying the liquid to the protective base material by any appropriate spreading method such as casting or coating; and a method that includes forming the pressure-sensitive adhesive layer on a separator similarly to the above method and transferring it to the base film. The surface of the base film, which will provide the pressure-sensitive adhesive layer, may be subjected to any appropriate surface treatment such as corona treatment for the purpose of improving the adhesion to the pressure-sensitive adhesive layer.

The protective film may also include an antistatic layer, which may be formed on one or both sides of the base film in order to prevent electrostatic charging during peeling.

The first protective film preferably uses the polyolefin resin among the above listed base film materials. The polyolefin resin may be an olefin homopolymer resin or an olefin copolymer resin such as a block or random copolymer of different olefins and optionally any other monomer. Examples of such polymers include propylene polymers, ethylene polymers such as low density polyethylene, high density polyethylene, medium density polyethylene, and linear low density polyethylene, ethylene-propylene copolymers, olefin polymers such as ethylene-α-olefin copolymers and reactor TPO, and olefin copolymers of olefins and other monomers, such as ethylene-methyl methacrylate copolymers. In particular, polyethylene, polypropylene, a polyethylene-polypropylene blend, and an ethylene-propylene copolymer are preferred.

The pressure-sensitive adhesive layer of the first protective film is preferably made of an acryl-type pressure-sensitive adhesive or an ethylene-vinyl acetate copolymer.

The thicknesses of the base film and the pressure-sensitive adhesive layer of the first protective may be determined as needed. The thickness of the base film is generally from about 10 to about 200 μm, preferably from 20 to 100 μm. The thickness of the pressure-sensitive adhesive layer is generally from 1 to 200 μm, preferably from 5 to 100 μm.

Polyester resins are preferred as materials for the base film of the protective film other than the first protective film, and polyethylene terephthalate is particularly preferred. The pressure-sensitive adhesive for use in such a protective film is preferably an acryl-type pressure-sensitive adhesive. The acryl-type pressure-sensitive adhesive, which is described below, may be used not only for the protective films other than the first protective film but also for the first protective film.

Acryl-type pressure-sensitive adhesives may be produced by crosslinking acryl-type polymer which obtained by copolymerizing different acryl monomers. The type of the acryl monomer may be an acrylate or methacrylate ester having a linear or branched alkyl group such as a methyl, ethyl, propyl, butyl, amyl, hexyl, heptyl, cyclohexyl, 2-ethylhexyl, octyl, nonyl, and decyl group. The adhesion properties can be improved by introducing functional groups or polar groups; the cohesion or the heat resistance can be improved by controlling the glass transition temperature of the resulting copolymer; the molecular weight can be increased by adding crosslinking reactivity so that the adhesive properties can be improved. For these or any other purposes, any of the following monomers may also be used: carboxyl-containing monomers such as (meth)acrylic acid, carboxyethyl acrylate, carboxypentyl acrylate, itaconic acid, maleic acid, fumaric acid, and crotonic acid; acid anhydride monomers such as maleic anhydride and itaconic anhydride; hydroxyl-containing monomers such as hydroxyethyl(meth)acrylate, hydroxypropyl(meth)acrylate, hydroxybutyl(meth)acrylate, and hydroxyhexyl(meth)acrylate; (N-substituted) amide monomers such as (meth)acrylamide, N,N-dimethyl(meth)acrylamide, N-butyl(meth)acrylamide, and N-methylol(meth)acrylamide; alkylaminoalkyl(meth)acrylate monomers such as aminoethyl(meth)acrylate and N,N-dimethylaminoethyl(meth)acrylate; alkoxyalkyl(meth)acrylate monomers such as methoxyethyl(meth)acrylate and ethoxyethyl(meth)acrylate; maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, and N-octylitaconimide; succinimide monomers such as N-(meth)acryloyloxymethylenesuccinimide and N-(meth)acryloyl-6-oxyhexamethylenesuccinimide; vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy-containing acrylic monomers such as glycidyl(meth)acrylate; glycol acrylate monomers such as polyethylene glycol(meth)acrylate, polypropylene glycol(meth)acrylate, methoxyethylene glycol(meth)acrylate, and methoxypolypropylene glycol(meth)acrylate; acrylate ester monomers such as tetrahydrofurfuryl(meth)acrylate, fluoro(meth)acrylate, silicone(meth)acrylate, and 2-methoxyethyl acrylate; and polyfunctional monomers such as divinylbenzene, butyl diacrylate, hexanediol di(meth)acrylate, (poly)ethylene glycol di(meth)acrylate, (poly)propylene glycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, epoxyacrylate, polyester acrylate, and urethane acrylate.

The acryl-type polymer may be prepared by subjecting a component monomer mixture to any appropriate polymerization process such as solution polymerization, emulsion polymerization, bulk polymerization, and suspension polymerization. In terms of heat resistance or adhesion properties, the acryl-type polymer preferably has a weight average molecular weight of 100,000 or more, more preferably of 200,000 or more, particularly preferably of 300,000 to 2,000,000.

The acryl-type pressure-sensitive adhesive layer may also be crosslinked by any appropriate method such as an internal or external crosslinking method. In general, the external crosslinking method is used in which an intermolecular crosslinking agent is added to the pressure-sensitive adhesive and the crosslinking process is performed. Examples of the intermolecular crosslinking agent include polyfunctional isocyanate crosslinking agents, epoxy crosslinking agents, melamine resin crosslinking agents, metal salt crosslinking agents, metal chelate crosslinking agents, amino resin crosslinking agents, and peroxide crosslinking agents.

The thicknesses of the base film and the pressure-sensitive adhesive layer of the protective film other than the first protective film may be determined as needed. The thickness of the base film is generally from about 10 to about 200 μm, preferably from 20 to 100 μm. The thickness of the pressure-sensitive adhesive layer is generally from 1 to 200 μm, preferably from 5 to 100 μm.

The retardation plate with protective films of the present invention may be prepared by a process that includes: providing at least two protective films whose adhesive strengths to their adherends differ from one another; and laminating the first protective film on a retardation plate and then sequentially laminating the other protective film(s) in such a manner that their adhesive strengths satisfy the above-stated relationship.

The retardation plate may be a pressure-sensitive adhesive retardation plate that has a pressure-sensitive adhesive layer on the side where no protective film is attached. In this case, a protective film-type pressure-sensitive retardation plate is provided.

As pressure-sensitive adhesive that forms pressure-sensitive adhesive layer is not especially limited, and, for example, acryl-type polymers; silicone-type polymers; polyesters, polyurethanes, polyamides, polyethers; fluorine-type and rubber-type polymers may be suitably selected as a base polymer. Especially, a pressure-sensitive adhesive such as acryl-type pressure-sensitive adhesives may be preferably used, which is excellent in optical transparency, showing adhesion characteristics with moderate wettability, cohesiveness and adhesive property and has outstanding weather resistance, heat resistance, etc.

Moreover, a pressure-sensitive adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The pressure-sensitive adhesive layer may contain additives, for example, such as natural or synthetic resins, adhesive resins, glass fibers, glass beads, metal powder, and filler comprising other inorganic powder etc., pigments, colorants and antioxidants. Moreover, it may be a pressure-sensitive adhesive layer that contains fine particle and shows optical diffusion nature.

Proper method may be carried out to provide an pressure-sensitive adhesive layer to one side or both sides of the retardation plate. As an example, about 10 to 40 weight % of the pressure-sensitive adhesive solution in which a base polymer or its composition is dissolved or dispersed, for example, toluene or ethyl acetate or a mixed solvent of these two solvents is prepared. A method in which this solution is directly applied on a retardation plate top using suitable developing methods, such as flow method and coating method, or a method in which an pressure-sensitive adhesive layer is once formed on a separator, as mentioned above, and is then transferred on a retardation plate may be mentioned.

An pressure-sensitive adhesive layer may also be prepared on one side or both sides of a retardation plate as a layer in which pressure-sensitive adhesives with different composition or different kind etc. are laminated together. Thickness of a pressure-sensitive adhesive layer may be suitably determined depending on a purpose of usage or adhesive strength, etc., and generally is 1 to 500 μm, preferably 5 to 200 μm, and more preferably 10 to 100 μm.

A separator is temporary attached to an exposed surface of a pressure-sensitive adhesive layer to prevent contamination etc., until it is practically used. Thereby, it can be prevented that foreign matter contacts pressure-sensitive adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned retardation plate, and the pressure-sensitive adhesive layer etc., using a method of adding UV absorbents, such as salicylic acid ester type compounds, benzophenol type compounds, benzotriazol type compounds, cyano acrylate type compounds, and nickel complex salt type compounds.

The pressure-sensitive adhesive type retardation plate with protective films may be laminated on any other optical material through the pressure-sensitive adhesive layer to form an adhesion type optical material with protective films.

The optical material may be any of various types of optical films, glass or a plastic film. The surface of the optical material may be subjected to appropriate surface treatment such as saponification, corona treatment, and anchor coat treatment. Such surface treatment can increase the adhesive strength between the retardation plate and the optical material.

The optical film may be a polarizing plate. A polarizing plate including a polarizer and a transparent protective film(s) provided on one or both sides of the polarizer is generally used. In such a polarizing plate, the surface of the protective film is subjected to the activation treatment.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials such as iodine, is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

As a materials forming the transparent protective film prepared on one side or both sides of the above-mentioned polarizer, with outstanding transparency, mechanical strength, heat stability, moisture cover property, isotropy, etc. may be preferable. For example, polyester-type polymer, such as polyethylene terephthalate and polyethylenenaphthalate; cellulose-type polymer, such as diacetyl cellulose and triacetyl cellulose; acryl-type polymer, such as poly methylmethacrylate; styrene-type polymer, such as polystyrene and acrylonitrile-styrene copolymer (AS resin); polycarbonate type polymer may be mentioned. Besides, as examples of the polymer forming a protective film, polyolefin-type polymer, such as polyethylene, polypropylene, polyolefin that has cyclo-type or norbornene structure, ethylene-propylene copolymer; vinyl chloride type polymer; amide-type polymer, such as nylon and aromatic polyamide; imide-type polymer; sulfone-type polymer; polyether sulfone-type polymer; polyether-ether ketone-type polymer; poly phenylene sulfide-type polymer; vinyl alcohol type polymer; vinylidene chloride-type polymer; vinyl butyral-type polymer; arylate-type polymer; polyoxymethylene-type polymer; epoxy-type polymer; or blend polymers of the above-mentioned polymers may be mentioned. The transparent protective film can be formed as a cured layer made of heat curing type or ultraviolet ray curing type resins, such as acryl-type, urethane-type, acryl urethane-type, epoxy-type, and silicone-type.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

In general, a thickness of the transparent protective film, which can be determined arbitrarily, is 1 to 500 μm, especially 5 to 200 μm in viewpoint of strength, work handling and thin layer.

The transparent protective film is preferably as colorless as possible. Thus, a protective film is preferably used which has a film-thickness-direction retardation of −90 nm to +75 nm, wherein the retardation (Rth) is represented by the formula: Rth=[(nx+ny)/2−nz]d, wherein nx and ny are each a principal refractive index in the plane of the film, nz is a refractive index in the film-thickness direction, and d is the thickness of the film. If a transparent protective film with such a thickness-direction retardation value (Rth) of −90 nm to +75 nm is used, coloring (optical coloring) of the polarizing plate can be almost avoided, which could otherwise be caused by any other transparent protective film. The thickness-direction retardation (Rth) is more preferably from −80 nm to +60 nm, particularly preferably from −70 nm to +45 nm.

As the transparent protective film, if polarization property and durability are taken into consideration, cellulose-type polymer, such as triacetyl cellulose, is preferable, and especially triacetyl cellulose film is suitable. In addition, when the transparent protective films are provided on both sides of the polarizer, the transparent protective films comprising same polymer material may be used on both of a front side and a back side, and the transparent protective films comprising different polymer materials etc. may be used. Isocyanate-type adhesive, polyvinyl alcohol-type adhesive, gelatin-type adhesive, vinyl-type, latex-type, aqueous polyurethane-type adhesive, aqueous polyester-type adhesive, and etc. may be used for adhesion processing for the above-mentioned polarizers and the protective films.

As the opposite side of the polarizing-adhering surface of the transparent protective film, a film treated with a hard coat layer and various processing aiming for antireflection, sticking prevention and diffusion or anti glare may be used.

A hard coat processing is applied for the purpose of protecting the surface of the polarizing plate from damage, and this hard coat film may be formed by a method in which, for example, a curable coated film with excellent hardness, slide property etc. is added on the surface of the transparent protective film using suitable ultraviolet curable type resins, such as acryl-type and silicone-type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the transparent protective film itself, and also they may be prepared as an optical layer different from the transparent protective film.

Further an optical film of the present invention may be used as other optical layers, such as a reflective plate, a transflective plate, a retardation plate (a half wavelength plate and a quarter wavelength plate included), and a viewing angle compensation film, a brightness enhancement film, which may be used for formation of a liquid crystal display etc. These are used in practice as an optical film, or as one layer or two layers or more of optical layers laminated with polarizing plate. As retardation plates are exemplified the above described.

Especially preferable polarizing plates are; a reflection type polarizing plate or a transflective type polarizing plate in which a reflective plate or a transflective reflective plate is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, type to one side of a polarizing plate through a transparent protective layer etc.

As an example of a reflection type polarizing plate, a plate may be mentioned on which, if required, a reflective layer is formed using a method of attaching a foil and vapor deposition film of reflective metals, such as aluminum, to one side of a matte treated transparent protective film. Moreover, a different type of plate with a fine concavo-convex structure on the surface obtained by mixing fine particle into the transparent protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the transparent protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the transparent protective film of the above-mentioned polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

A description of the above-mentioned elliptically polarizing plate or circularly polarizing plate on which the retardation plate is laminated to the polarizing plates will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such viewing angle compensation retardation plates, a retardation plate, an orientation film of a liquid crystal polymer, or an orientation layer of a liquid crystal polymer supported on a transparent substrate are included. Ordinary retardation plate is a polymer film having property that is processed by uniaxially stretching in the plane direction, while the viewing angle compensation retardation plate used is a bidirectional stretched film having birefringence property that is processed by biaxially stretching in the plane direction, or a film, which is controlled the refractive index in the thickness direction, that is processed by uniaxially stretching in the plane direction and is processed by stretching in the thickness direction, and inclined orientation film. As inclined orientation film, for example, a film obtained using a method in which a heat shrinking film is adhered to a polymer film, and then the combined film is heated and stretched or shrunk under a condition of being influenced by a shrinking force, or a film in which a liquid crystal polymer is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarization light with a predetermined polarization axis, or circularly polarization light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light region, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light region, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

The retardation plate with protective films, the pressure-sensitive adhesive type retardation plate with protective films or the pressure-sensitive adhesive type optical material with protective films of the present invention is preferably used to form various types of image displays such as liquid crystal displays. Liquid crystal displays may be formed according to conventional techniques. Specifically, liquid crystal displays are generally formed by appropriately assembling a liquid crystal cell and the optical film and optionally other components such as a lighting system and incorporating a driving circuit according to any conventional technique. Any type of liquid crystal cell may also be used such as a TN type, an STN type and a π type.

Suitable liquid crystal displays, such as liquid crystal display with which the optical film has been located at one side or both sides of the liquid crystal cell, and with which a backlight or a reflective plate is used for a lighting system may be manufactured. In this case, the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. The retardation plate with protective films, the pressure-sensitive adhesive type retardation plate with protective films or the pressure-sensitive adhesive type optical material with protective films of the present invention is applied to the organic EL display. Generally, in organic EL display, a transparent electrode, an organic luminescence layer and a metal electrode are laminated on a transparent substrate in an order configuring an illuminant (organic electro luminescence illuminant). Here, a organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electron injection layer comprising such a luminescence layer and perylene derivatives, etc.; laminated material of these hole injection layers, luminescence layer, and electron injection layer etc.

An organic EL display emits light based on a principle that positive hole and electron are injected into an organic luminescence layer by applying voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electron injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by application of voltage, and at the same time equipped with a metal electrode on a back side of organic luminescence layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

The present invention is specifically described using the examples below, which are not intended to limit the scope of the present invention. The retardation plates and the protective films used in the examples and the comparative examples are shown below.

Retardation plate α: a 30 μm-thick retardation plate prepared by a process including the steps of forming a film by casting from a methylene chloride solution of a polycarbonate resin (Panlite manufactured by Teijin Chemicals Ltd.) and uniaxially stretching the film.

Retardation plate β: a 40 μm-thick retardation plate prepared by a process including the steps of forming a film by casting from a methylene chloride solution of a cyclic olefin resin (Arton manufactured by JSR Corporation) and uniaxially stretching the film.

Retardation plate γ: a 40 μm-thick retardation plate prepared by a process including the steps of forming a film by melting and extrusion of a cyclic olefin resin (Zeonoa manufactured by Zeon Corporation) and uniaxially stretching the film.

Retardation plate δ: a 5 μm-thick retardation plate prepared by a process including the step of polymerizing and fixing the following liquid crystal monomer, while orienting it.

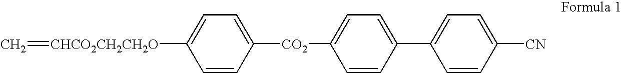

Protective film A: a two-layer structure protective film (Protect Tape #6221F manufactured by Sekisui Chemical Co., Ltd.) composed of a 40 μm-thick polyethylene base material layer and a 23 μm-thick ethylene-vinyl acetate copolymer pressure-sensitive adhesive layer.

Protective film B: a protective film (RB-100 manufactured by NITTO DENKO CORPORATION) having a structure composed of a 40 μm-thick base film of a polypropylene-polyethylene blend and a 5 μm-thick coating of an acryl-type pressure-sensitive adhesive formed on the base film.

Protective film C: 2-ethylhexyl acrylate: acrylic acid=100:6 (in weight ratio) were polymerized in toluene by a conventional method to form a copolymer (an acrylic polymer); 100 parts by weight of the polymer solid was mixed with 5 parts of an isocyanate crosslinking agent (Coronate L manufactured by Nippon Polyurethane Industry Co., Ltd.) to form a pressure-sensitive adhesive solution; the resulting pressure-sensitive adhesive solution was applied to a 38 μm-thick polyethylene terephthalate film (Lumiror S27 manufactured by Toray Industries, Inc.) so as to provide a solid thickness of 20 μm, then heated and dried at 120° C. for 3 minutes, and aged at 50° C. for 2 days to form the protective film.

(Adhesive Strength)

The adhesive strength of each protective film is the adhesive strength with which the film actually adheres to the adherend. The adhesive strength of the first protective film is the adhesive strength on the retardation plate, while the adhesive strength of the second protective film is the adhesive strength on the base film of the first protective film. The adhesive strength is a value (N/50 mm) measured by a process including the steps of bonding the protective film (200 mm×50 mm) to the adherend by a single back-and-forth motion of a 20 N roller and then measuring the adhesive strength at a peeling speed of 0.3 m/minute, a peeling angle of 180° and room temperature (23° C.). The measurement was performed according to JIS Z 0237.

### Example 1

The retardation plate a (200 mm×300 mm) was fixed on a SUS plate with a temporary fixing tape, and then the protective film A (serving as the first protective film) was attached to the surface of the retardation plate a with a roll laminator under a tension of 10 N/m at a laminating speed of 1 m/minute. The protective film C (serving as the second protective film) was further attached to the first protective film by the same attaching method as for the first protective film to form a retardation plate with protective films with a size of 180 mm×280 mm. The retardation plate with protective films was finally obtained by cutting the temporary fixing tape and other parts, 20 mm in length and 20 mm in width.

### Examples 2 to 5 and Comparative Examples 1 to 3

Retardation plate with protective films were prepared using the process of Example 1, except that the retardation plate, the first protective film and the second protective film were changed to other types as shown in Table 1.

The retardation plate with protective films obtained in each of the examples and the comparative examples was evaluated as described below. The results are shown in Table 1.

(Lamination Performance)

The prepared retardation plate with protective films was evaluated as to whether any unusual appearance such as separation or peeling of the protective film was found or not and whether curling occurred or not. Cases where there was no unusual appearance and the maximum curl height was 30 mm or less were evaluated as “good.” In the other cases, the defect was reported. All the examples were evaluated as “good.” In Comparative Examples 1 and 3, the maximum curl height exceeded 30 mm. In Comparative Example 2, separation of the second protective film occurred.

(Peelability)

The four sides of the prepared retardation plate with protective films were fixed on a SUS plate with a 20 mm-width double-side tape. Thereafter, a cellophane tape was laminated to the second protective film, and then the protective films were peeled off from the corner parts. At this time, cases where all the protective films were easily peeled off were evaluated as “good,” and other cases where wrinkling or cracking occurred in the retardation plate during peeling were evaluated as “difficult.” When peeling was required twice, that is reported in Table 1.

(Workability/Appearance)

Lifting the prepared retardation plate with protective films in a horizontal manner by one hand was repeated 10 times. Thereafter, the protective film was peeled off, when the retardation plate was evaluated as to whether or not folding, wrinkling or cracking occurred in it. Cases where neither folding, wrinkling nor cracking occurred were evaluated as “good.” When folding, wrinkling or cracking occurred in the retardation plate, the fact was reported in Table 1. In Comparative Example 3, the workability became poor, because of poor peelability of the protective film.

TABLE 1

| | Retardation Plate | | | First Protective Film | | | Second Protective Film | | | | | |
|---|---|---|---|---|---|---|---|---|---|---|---|---|
| | | | Thick- | | Base | Adhesive | | Base | Adhesive | | | |
| | | | ness | | Film | Strength | | Film | Strength | Lamination | Peel- | Workability/ |
| | Type | Material | (μm) | Type | Material | (N/50 mm) | Type | Material | (N/50 mm) | Performance | ability | Appearance |
| Example 1 | α | PC | 30 | A | PE | 0.04 | C | PET | 0.16 | Good | Good | Good |
| Example 2 | α | PC | 30 | B | PE/PP | 0.08 | C | PET | 0.17 | Good | Good | Good |
| Example 3 | β | Cyclic | 40 | A | PE | 0.04 | C | PET | 0.16 | Good | Good | Good |
| | | Olefln | | | | | | | | | | |
| Example 4 | γ | Cyclic | 40 | A | PE | 0.04 | C | PET | 0.16 | Good | Good | Good |
| | | Olefln | | | | | | | | | | |
| Example 5 | δ | Liquid | 5 | A | PE | 0.03 | C | PET | 0.16 | Good | Good | Good |
| | | Crystal | | | | | | | | | | |
| | | Polymer | | | | | | | | | | |
| Comparative | α | PC | 30 | A | PE | 0.04 | — | — | — | Curling | Good | Retardation |
| Example 1 | | | | | | | | | | | | Plate Folding |
| Comparative | α | PC | 30 | A | PE | 0.04 | A | PET | 0.03 | Separation | Peeling | Retardation |
| Example 2 | | | | | | | | | | | Twice | Plate Folding |
| Comparative | α | PC | 30 | C | PET | 0.32 | — | — | — | Curling | Difficult | Poor |
| Example 3 | | | | | | | | | | | | Workability |

In Table 1, PC represents polycarbonate, PE polyethylene, PE/PP a blend of polyethylene and polypropylene, and PET polyethylene terephthalate.

### INDUSTRIAL APPLICABILITY

The retardation plate used in the protective film-type retardation plate of the present invention may be used for various types of image displays such as liquid crystal displays, organic electroluminescent displays and plasma display panels. In a manufacturing process, the retardation plate with protective films can form a retardation plate-laminated product or a retardation plate-bonded product without impairing workability or appearance.

1. A retardation plate with protective films, comprising:
a retardation plate; and
at least two protective films that each comprise a base film and a pressure-sensitive adhesive layer formed on one side of the base film and are sequentially laminated on the retardation plate, wherein
the first protective film laminated on the retardation plate differs in adhesive strength to adherend from the protective film or films other than the first protective film, and
the first protective film has the lowest adhesive strength.

2. The retardation plate with protective films according to claim 1, wherein the difference between the adhesive strengths of the first protective film laminated on the retardation plate and a second protective film adjacent to the first protective film is 0.05 N/50 mm or more.

3. The retardation plate with protective films according to claim 1, wherein the first protective film laminated on the retardation plate has an adhesive strength of 0.01 N/50 mm to 0.3 N/50 mm.

4. The retardation plate with protective films according to claim 1, wherein the base film of the first protective film laminated on the retardation plate is a polyolefin-type film, and the base film of the other protective film is a polyester-type film.

5. The retardation plate with protective films according to claim 1, wherein the retardation plate has a thickness of 1 μm to 60 μm.

6. A method of manufacturing the retardation plate with protective films according to claim 1, comprising:
providing at least two protective films that each comprise a base film and a pressure-sensitive adhesive layer formed on one side of the base film and differ from one another in adhesive strength to adherend;
laminating, on the retardation plate, a first one of the protective films that has the lowest adhesive strength; and
then laminating the other protective film or films sequentially.

7. A pressure-sensitive adhesive type retardation plate with protective films, comprising the retardation plate with protective films according to claim 1 and a pressure-sensitive adhesive layer formed on a side of the retardation plate where no protective film is laminated.

8. A pressure-sensitive adhesive type optical material with protective films, comprising the pressure-sensitive adhesive type retardation plate with protective films according to claim 7 and another optical material laminated on the retardation plate through the pressure-sensitive adhesive layer.

9. A method of manufacturing the retardation plate with protective films according to claim 2, comprising:
providing at least two protective films that each comprise a base film and a pressure-sensitive adhesive layer formed on one side of the base film and differ from one another in adhesive strength to adherend;
laminating, on the retardation plate, a first one of the protective films that has the lowest adhesive strength; and
then laminating the other protective film or films sequentially.

10. A method of manufacturing the retardation plate with protective films according to claim 3, comprising:
providing at least two protective films that each comprise a base film and a pressure-sensitive adhesive layer formed on one side of the base film and differ from one another in adhesive strength to adherend;
laminating, on the retardation plate, a first one of the protective films that has the lowest adhesive strength; and
then laminating the other protective film or films sequentially.

11. A method of manufacturing the retardation plate with protective films according to claim 4, comprising:
providing at least two protective films that each comprise a base film and a pressure-sensitive adhesive layer formed on one side of the base film and differ from one another in adhesive strength to adherend;
laminating, on the retardation plate, a first one of the protective films that has the lowest adhesive strength; and
then laminating the other protective film or films sequentially.

12. A method of manufacturing the retardation plate with protective films according to claim 5, comprising:
providing at least two protective films that each comprise a base film and a pressure-sensitive adhesive layer formed on one side of the base film and differ from one another in adhesive strength to adherend;
laminating, on the retardation plate, a first one of the protective films that has the lowest adhesive strength; and
then laminating the other protective film or films sequentially.

13. A pressure-sensitive adhesive type retardation plate with protective films, comprising the retardation plate with protective films according to claim 2 and a pressure-sensitive adhesive layer formed on a side of the retardation plate where no protective film is laminated.

14. A pressure-sensitive adhesive type retardation plate with protective films, comprising the retardation plate with protective films according to claim 3 and a pressure-sensitive adhesive layer formed on a side of the retardation plate where no protective film is laminated.

15. A pressure-sensitive adhesive type retardation plate with protective films, comprising the retardation plate with protective films according to claim 4 and a pressure-sensitive adhesive layer formed on a side of the retardation plate where no protective film is laminated.

16. A pressure-sensitive adhesive type retardation plate with protective films, comprising the retardation plate with protective films according to claim 5 and a pressure-sensitive adhesive layer formed on a side of the retardation plate where no protective film is laminated.
